(19) United States
(12) Patent Application Publication
(10) Pub. No.: US 2008/0302641 A1
(43) Pub. Date: Dec. 11, 2008

(54) Multifunctional key device for an electronic product

(76) Inventor: Fei-Ming Su, Changhua Hsien (TW)

Correspondence Address: BLISS MCGLYNN, P.C., 2075 WEST BIG BEAVER ROAD, SUITE 600, TROY, MI, 48084, US

(21) Appl. No.: 11/811,320

(22) Filed: Jun. 8, 2007

(51) Int. Cl. H01H 9/00; H01H 25/04; H01H 9/04

(52) U.S. Cl. 200/302.3

(57) ABSTRACT

A multifunctional key device is provided for an electronic product which has a top cover with a receiving hole, and a micro stick switch coupled electrically to a circuit board. The multifunctional key device includes a rubber sealing member sandwiched between the top cover and the circuit board, and a key button body. The rubber sealing member includes a skirt portion extending upwardly from a top face thereof into the receiving hole, and a button coupling portion integral with the skirt portion and having a top open end. The key button body is fitted to the micro stick switch, and has a top end face exposed from the top open end of the button coupling portion to permit a user's finger to press directly the key button body.

### BACKGROUND OF THE INVENTION

1. Field of the Invention

This invention relates to a control device, more particularly to a multifunctional key device for an electronic product, such as a handheld electronic product.

2. Description of the Related Art

Referring to FIGS. 1 and 2, a conventional watertight key unit 20, as disclosed by the applicant in U.S. Pat. No. 6,956,180, is adapted to be installed in a handheld electronic product 10. The electronic product 10 includes a top cover 11, a circuit board 12 fastened inside the top cover 11, and a micro stick switch 13 and a plurality of pressable switches 14 coupled electrically to the circuit board 12.

The watertight key unit 20 has an elastic sealing part 21, a multifunctional button 22, and a plurality of single-function buttons 212. The elastic sealing part 21 is made of rubber, and is sandwiched between the top cover 11 and the circuit board 12. The multifunctional button 22 extends through a central hole 111 in the top cover 11, and has an upper wall 221 and a surrounding wall 222 that are made of plastic and that cooperatively define an insert hole 223, and an elastic cap 224 that is made of rubber and that is integral with the elastic sealing part 21 and covering the upper and surrounding walls 221, 222. The micro stick switch 13 is snugly fitted into and engages the insert hole 223 so as to be operable through the multifunctional button 22. The single-function buttons 212 extend respectively through side holes 112 in the top cover 11 to connect respectively with the pressable switches 14.

In use, a user needs only one finger to press the elastic cap 224 so as to operate the multifunctional button 22, which in turn activates the micro stick switch 13. Hence, operation of the electronic product 10 is easy. Simultaneously, through waterproof and dustproof effects of the elastic sealing part 21, components mounted between the top cover 11 and the circuit board 12 are protected.

Although the aforementioned watertight key unit 20 can achieve its intended purpose, during pressing of the elastic cap 224 by the user, because the elastic cap 224 of the watertight key unit 20 is made of rubber, which has an effect of damping movement, transmission of movement from the elastic cap 224 to the micro stick switch 13 is slow, resulting in delayed operation of the micro stick switch 13. Hence, the watertight key unit 20 has poor sensitivity.

### SUMMARY OF THE INVENTION

Therefore, the object of the present invention is to provide a multifunctional key device for an electronic product that is capable of overcoming the aforementioned drawbacks of the prior art.

According to this invention, a multifunctional key device is provided for an electronic product which has a top cover provided with a receiving hole, a circuit board fixed inside the top cover, and a micro stick switch mounted on and coupled electrically to the circuit board. The multifunctional key device comprises a rubber sealing member and a key button body. The rubber sealing member is adapted to be sandwiched between the top cover and the circuit board, and includes top and bottom faces, a skirt portion extending upwardly from the top face and adapted to extend into the receiving hole in the top cover, and a button coupling portion integral with the skirt portion. The key button body is made of plastic, and is adapted to be fitted to the micro stick switch. The key button body extends upwardly within the skirt portion. The button coupling portion is coupled to and surrounds the key button body, and has a top open end. The key button body has a top end face exposed from the top open end of the button coupling portion to permit a user's finger to press directly the key button body.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded perspective view of an electronic product incorporating a watertight key unit disclosed in U.S. Pat. No. 6,956,180;

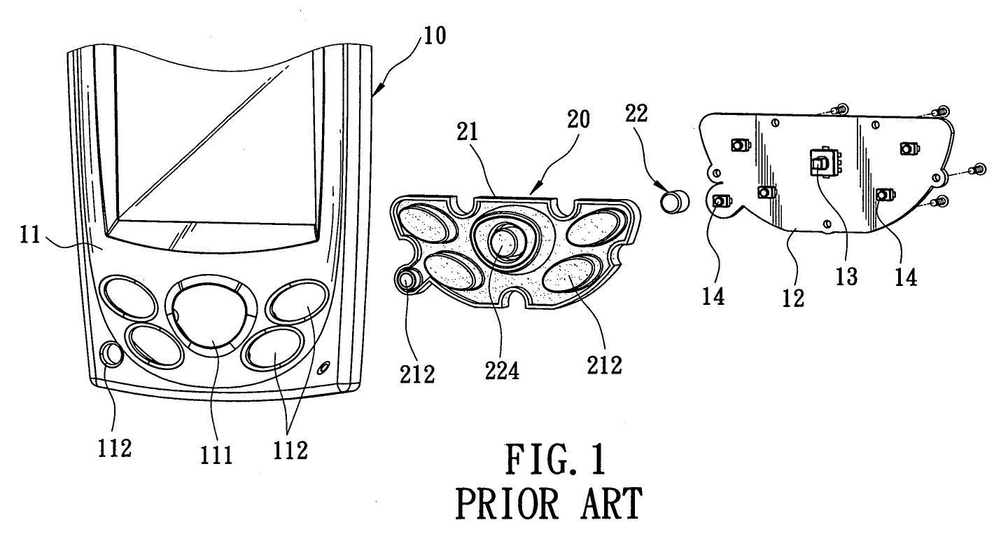

FIG. 2 is a fragmentary sectional view of the electronic product of FIG. 1 in an assembled state;

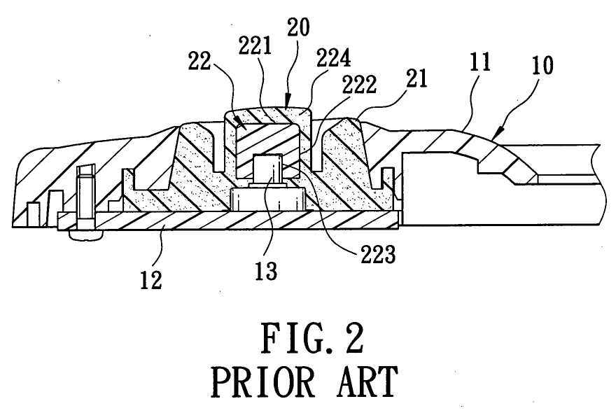

FIG. 3 is an exploded perspective view of an electronic product according to the preferred embodiment of the present invention;

FIG. 4 is an assembled perspective view of the preferred embodiment; and

FIG. 5 is a fragmentary sectional view of the preferred embodiment in an assembled state.

### DETAILED DESCRIPTION OF THE PREFERRED EMBODIMENT

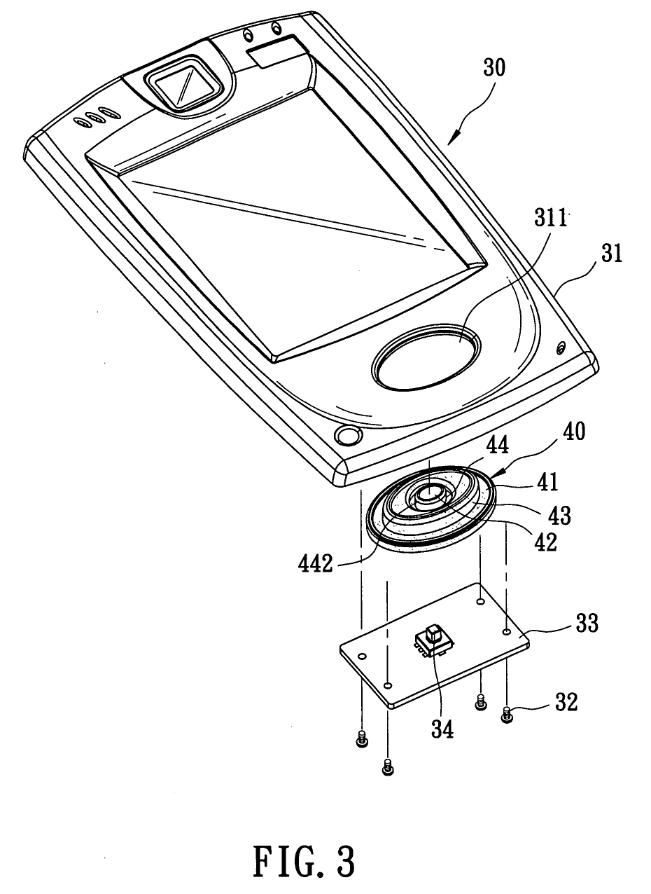

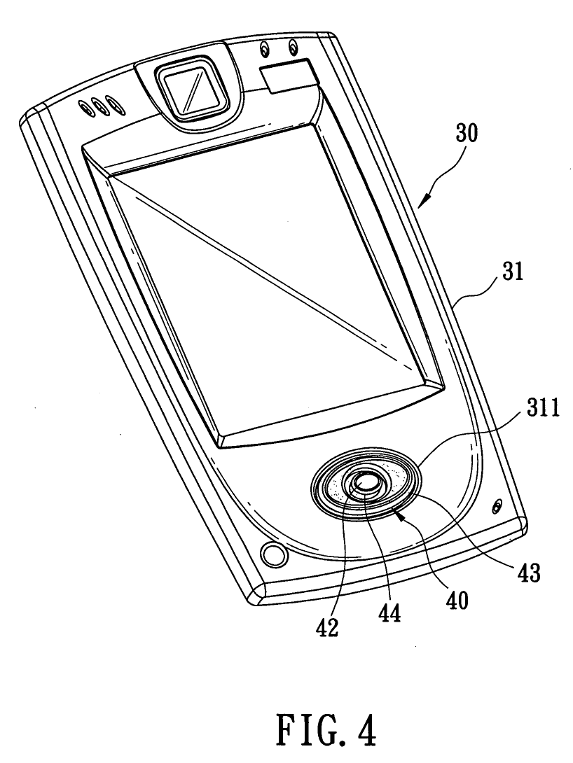

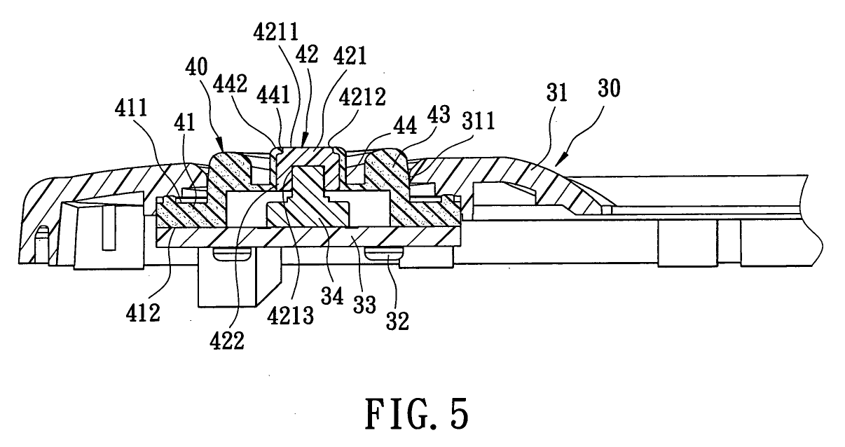

FIGS. 3, 4, and 5 illustrate the preferred embodiment of an electronic product 30, such as a personal digital assistant (PDA), an electronic game device, etc., according to the present invention. The electronic product 30 includes a top cover 31, a circuit board 33, a micro stick switch 34, and a multifunctional key device 40.

The top cover 31 has a receiving hole 311.

The circuit board 33 is fastened fixedly inside the top cover 31 through a plurality of screws 32.

The micro stick switch 34 is mounted on and is coupled electrically to the circuit board 33. The micro stick switch 34 may be a multifunctional switch that may be moved in forward, backward, left, and right directions, and possibly, in addition, downward and diagonal directions.

The multifunctional key device 40 includes a rubber sealing member 41 and a key button body 42. The rubber sealing member 41 is sandwiched between the top cover 31 and the circuit board 33, and includes top and bottom faces 411, 412, a skirt portion 43 extending upwardly from the top face 411 into the receiving hole 311 in the top cover 31, and a button coupling portion 44 integral with the skirt portion 43. The key button body 42 extends upwardly from the top face 411 within the skirt portion 43, and includes a top wall 421 having a top end face 4211 and a top peripheral groove 4212 formed around the top end face 4211, and a surrounding wall 422 extending downwardly from and cooperating with the top wall 421 to define an insert hole 4213. The micro stick switch 34 is inserted fittingly into the insert hole 4213. The button coupling portion 44 is coupled to and surrounds the key button body 42. The button coupling portion 44 has a top open end 441, and a top flange 442 projecting inwardly from the top open end 441 and extending into the peripheral groove 4212. The top end face 4211 of the top wall 421 of the key button body 42 extends into the top open end 441 of the button coupling portion 44 so as to be exposed therefrom. As such, a user's finger is permitted to press directly the key button body 42.

In this embodiment, the rubber sealing member 41 has a Shore hardness in the range of HS30˜80.

It should be noted that during manufacture of the multifunctional key device 40 of the preferred embodiment, the key button body 42 and the rubber sealing member 41 can be molded integrally through an insert-molding or a double-injection process, so that the key button body 42 and the rubber sealing member 41 have a strong connection.

In use, a user needs only to place a finger on the top wall 421 of the key button body 42 to operate the key button body 42 and to move therealong the micro stick switch 34 in a predetermined direction. Because the user's finger is in direct contact with the key button body 42, which is not resilient and which has no damping effect, rapid operation of the micro stick switch 34 is possible, so that the multifunctional key device 40 of the present invention has good sensitivity. This is advantageous during use of the electronic product 30. Further, through the waterproof and dustproof functions of the rubber sealing member 41, the components installed between the top cover 31 and the circuit board 33 can be protected.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A multifunctional key device for an electronic product, the electronic product having a top cover provided with a receiving hole, a circuit board fixed inside the top cover, and a micro stick switch mounted on and coupled electrically to the circuit board, said multifunctional key device comprising:
a rubber sealing member adapted to be sandwiched between the top cover and the circuit board, and including top and bottom faces, a skirt portion extending upwardly from said top face and adapted to extend into the receiving hole in the top cover, and a button coupling portion integral with said skirt portion; and
a key button body that is made of plastic and that is adapted to be fitted to the micro stick switch, said key button body extending upwardly within said skirt portion;
said button coupling portion being coupled to and surrounding said key button body and having a top open end, said key button body having a top end face exposed from said top open end of said button coupling portion to permit a user's finger to press directly said key button body.

2. The multifunctional key device of claim 1, wherein said key button body has a top peripheral groove formed around said top end face, and said button coupling portion has a top flange projecting inwardly from said top open end and extending into said peripheral groove.

3. The multifunctional key device of claim 1, wherein said key button body and said rubber sealing member are insert-molded together.

4. The multifunctional key device of claim 1, wherein said rubber sealing member has a Shore hardness in the range of HS30˜80.
